(19) United States
(12) Patent Application Publication
(10) Pub. No.: US 2006/0162198 A1
(43) Pub. Date: Jul. 27, 2006

(54) Flame simulating assembly

(75) Inventors: Kristoffer Hess, Cambridge (CA); Michael Jach, Kitchener (CA)

Correspondence Address: VALENTINE A. COTTRILL, SUITE 1020 50 QUEEN STREET NORTH, KITCHENER, ON, N2H6M2, CA

(73) Assignee: Dimplex North America Limited, Cambridge (CA)

(21) Appl. No.: 11/038,118

(22) Filed: Jan. 21, 2005

(51) Int. Cl. G09F 19/00

(52) U.S. Cl. 40/428

(57) ABSTRACT

A flame simulating assembly including a simulated fuel bed, a screen having a front surface disposed proximal to the simulated fuel bed and a back surface positioned opposite to the front surface, and a flame picture projector for projecting motion pictures of flames onto the back surface, for display thereof at the front surface. The front surface of the screen is partially reflective, for providing a reflected image of the simulated fuel bed appearing to be disposed at least partially behind the motion pictures of flames displayed at the front surface.

### FIELD OF THE INVENTION

The present invention is related to a flame simulating assembly.

### BACKGROUND OF THE INVENTION

Various types of flame simulating assemblies are known. One type of known flame simulating assembly typically includes a simulated fuel bed, one or more light sources, a screen disposed behind the simulated fuel bed for diffusing and transmitting light from the light source, and a flicker element for causing light from the light source to fluctuate, or flicker, to simulate flames. Images of flames are provided by fluctuating light from the light source which is transmitted through the screen. Typically, the known electric flame simulating assembly also includes a flame effect element which configures fluctuating light from the light source to form the images of flames which are transmitted through the screen. Such a flame simulating assembly is disclosed in U.S. Pat. No. 5,642,580 (Hess et al.).

Usually, the flame simulating assembly also includes an electric heat source and a fan, for heating the room in which the flame simulating assembly is located. The electric heat source can be, for example, one or more electric heating elements, and the fan blows heated air out of the flame simulating assembly and into the room.

The typical flame simulating assembly is sold with a trim package according to the purchaser's preference. For example, most flame simulating assemblies are sold with a trim package which, upon assembly, resembles a natural fireplace hearth and mantle and associated woodwork. However, flame simulating assemblies positioned inside simulated stoves (e.g., cabinets which resemble wood-burning stoves) are also popular. For the purposes hereof, it will be understood that a flame simulating assembly includes a device for simulating flames, regardless of whether, for example, the device is installed in a simulated stove or fireplace.

In another type of flame simulating assembly, strips of colored cloth ribbons are suspended behind a screen. The ribbons are moved by a forced stream of air from a fan, and illuminated to simulate flames, when viewed through the screen. Such a flame simulating assembly is disclosed in U.S. Pat. No. 4,965,707 (Butterfield).

In a third type of known flame simulating assembly, a series of pictorial images of flames are shown on a display panel adapted to show such images. For example, in GB 2 242 737 (Shute), an artificial fire unit is disclosed which includes a television set and a video recorder for playing recordings of fires on the television set. The artificial fire unit is positioned in a cabinet so that it appears to be “a conventional domestic fire unit” (p. 2, at lines 19-20).

Other relevant known prior art includes GB 2 288 052 (Stranney), and U.S. patent application Ser. No. 10/120,889 (published as no. U.S. 2003/0201957) (Mix et al.). In each of these, an alternative to the then known flame simulating assemblies is disclosed in which pictorial images of flames are provided.

For example, in GB 2 288 052, videotaped images of flames are projected onto one or more opaque, or semi-opaque, screens to simulate a fire, and appropriate audio effects are also provided.

In Mix et al., a display is disclosed which is driven by a controller, and/or driven by other peripheral components. The display is described as being a “flat-panel display”, and includes an LCD display or a plasma screen display.

In summary, although known flame simulating assemblies can provide a realistic simulation of a natural wood or coal fire in a real fireplace or stove, there are a number of aspects of known flame simulating assemblies which are not as realistic as might be desired, or which otherwise need improvement. For example, an entire flat panel display which is a LCD panel would be relatively expensive. Also, the overall simulations provided by the known flame simulating assemblies in which pictorial images of flames are displayed tend to be somewhat lacking in realism. In particular, because the pictures of flames are presented on a flat panel, and the three-dimensional aspects (if any) of the pictures are generally relied upon to provide an illusion of depth, the pictorial images provided in the third type of prior art flame simulating assembly tend to appear somewhat flat (i.e., lacking in depth), and thus somewhat ineffective.

There is therefore a need for an improved flame simulating assembly to overcome at least one of the disadvantages of the prior art.

### SUMMARY OF THE INVENTION

In its broad aspect, the invention provides a flame simulating assembly including a simulated fuel bed, a screen having a front surface disposed proximal to the simulated fuel bed and a back surface positioned opposite to the front surface, and a flame picture projector. The flame picture projector is for creating a plurality of motion pictures of flames from recorded motion pictures stored on a storage medium accessible thereby, and projecting light beams carrying the motion pictures of flames to the back surface of the screen. The screen is adapted to display the motion pictures of flames at its front surface, and the front surface is partially reflective, for providing a reflected image of the simulated fuel bed appearing to be disposed at least partially behind the motion pictures of flames displayed at the front surface. The result is that the motion pictures of flames appear to be substantially centrally positioned relative to the simulated fuel bed.

In another aspect, the back surface of the screen is non-planar so that the motion pictures of flames are displayed in three dimensions at the front surface of the screen.

In yet another aspect, the simulated fuel bed includes one or more simulated fuel elements and a simulated ember bed, the simulated ember bed being positioned below the simulated fuel elements. The simulated ember bed has an exterior surface shaped and colored to simulate embers and an opposed interior surface. The simulated ember bed includes a plurality of light-transmitting portions for resembling glowing embers upon light being transmitted therethrough.

In another of its aspects, the simulated ember bed is positioned so that the light beams from the flame picture projector are transmitted through the light-transmitting portions to simulate glowing embers.

In another aspect, the flame simulating assembly additionally includes an ember bed mirror positioned to direct light beams from the flame picture projector substantially towards the light-transmitting portions of the simulated ember bed.

In yet another of its aspects, the flame simulating assembly additionally includes one or more ember bed light sources. The light-transmitting portions of the simulated ember bed are positioned in a path of light from the ember bed light sources so that light is transmitted through the light-transmitting portions to simulate glowing embers.

In yet another aspect, the screen includes an upper portion which is at least partially transparent and which is disposed distal to the simulated fuel bed.

In another of its aspects, the flame picture projector includes a picture display device for accessing the storage medium to provide a first display of the motion pictures of flames, said first display being projectable onto the back surface of the screen.

In yet another aspect, the flame picture projector includes a projector light source positioned to direct light therefrom through the picture display device to project the motion pictures of flames onto the back surface of the screen.

In another of its aspects, the flame picture projector includes a projector light source positioned to direct light therefrom onto the first display, the light being reflected by the first display to project the motion pictures of flames onto the back surface of the screen.

In yet another aspect, the flame simulating assembly additionally includes one or more mirrors for reflecting the light beams from the flame picture projector towards the back surface of the screen.

### BRIEF DESCRIPTION OF THE DRAWINGS

The invention will be better understood with reference to the drawings, in which:

FIG. 1A is a cross-section of a preferred embodiment of a flame simulating assembly of the invention in which a flame picture projector is positioned in a housing thereof behind a screen;

FIG. 1B is a schematic showing a preferred embodiment of the flame picture projector;

FIG. 1C is a front view of the flame simulating assembly of FIG. 1A;

FIG. 1D is a cross-section of a portion of the simulated fuel bed, drawn at a larger scale;

FIG. 1E is a schematic illustrating a preferred embodiment of a process for storing and modifying one or more motion pictures of a natural fire;

FIG. 1F is a schematic showing an alternative embodiment of the flame picture projector;

FIG. 1G is a cross-section of another alternative embodiment of the flame simulating assembly, drawn at a smaller scale;

FIG. 1H is a cross-section of another alternative embodiment of the flame simulating assembly;

FIG. 2 is a cross-section of an alternative embodiment of the flame simulating assembly showing the back surface of the screen spaced apart from a front surface thereof;

FIG. 3 is a cross-section of another alternative embodiment of the flame simulating assembly, in which the flame picture projector is positioned above and at least partially in front of the screen;

FIG. 4A is a cross-section of another alternative embodiment of the flame simulating assembly in which the flame picture projector is positioned adjacent to a ceiling of the housing;

FIG. 4B is a cross-section of another alternative embodiment of the flame simulating assembly;

FIG. 5 is a cross-section of another alternative embodiment of the flame simulating assembly in which the flame picture projector is positioned below the simulated fuel bed;

FIG. 6 is a cross-section of an alternative embodiment of the flame simulating assembly of the invention in which the screen includes a substantially transparent portion positioned proximal to the ceiling of the housing;

FIG. 7 is a cross-section of another alternative embodiment in which the screen's top edge is spaced apart from the ceiling by a predetermined amount;

FIG. 8 is a cross-section of another alternative embodiment of the flame simulating assembly of the invention in which a reflector is positioned under the simulated ember bed, for reflecting light into the simulated ember bed; and

FIG. 9 is a cross-section of another alternative embodiment of the flame simulating assembly in which a front reflector is positioned in front of the simulated fuel bed, for reflecting light onto the simulated fuel bed.

### DETAILED DESCRIPTION OF THE PREFERRED EMBODIMENT(S)

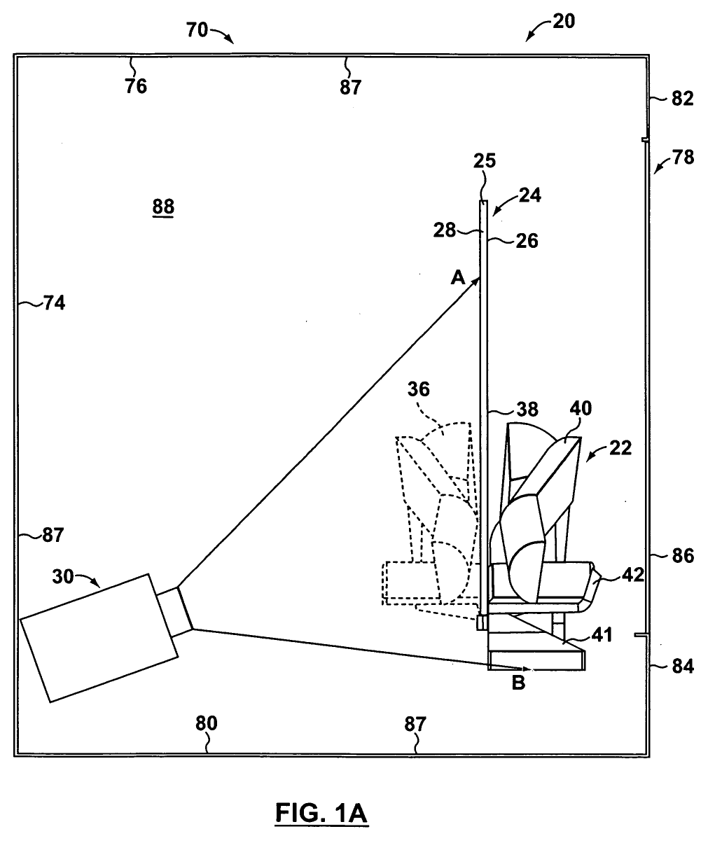

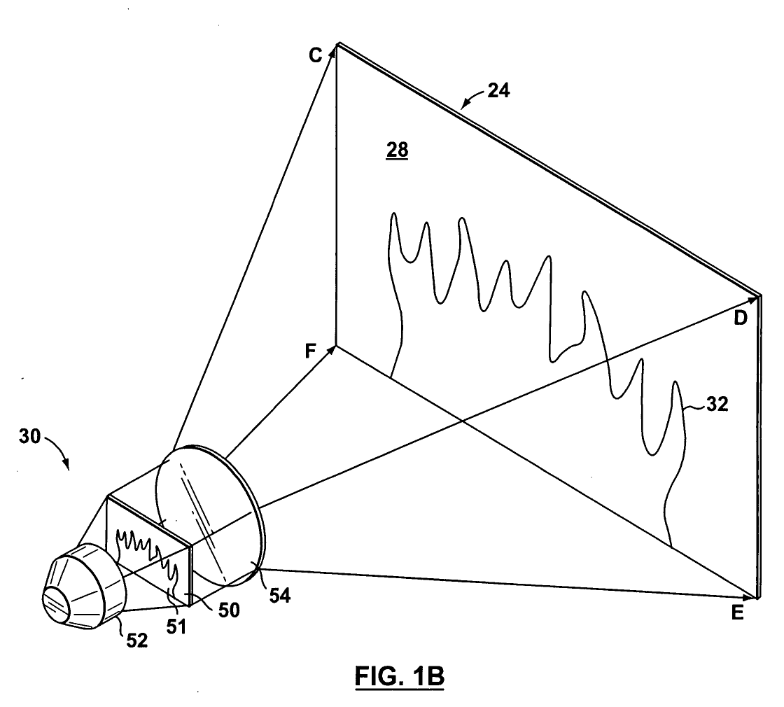

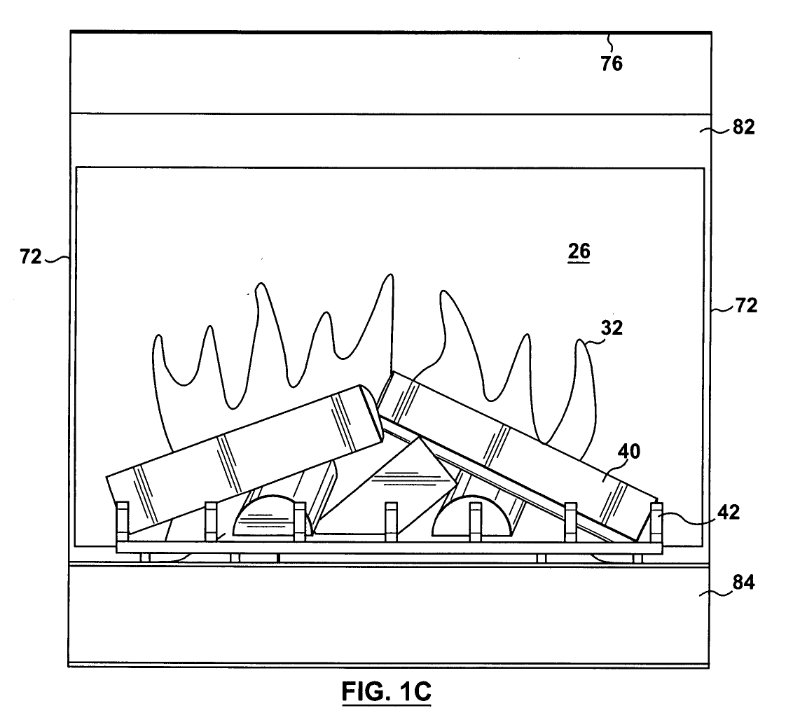

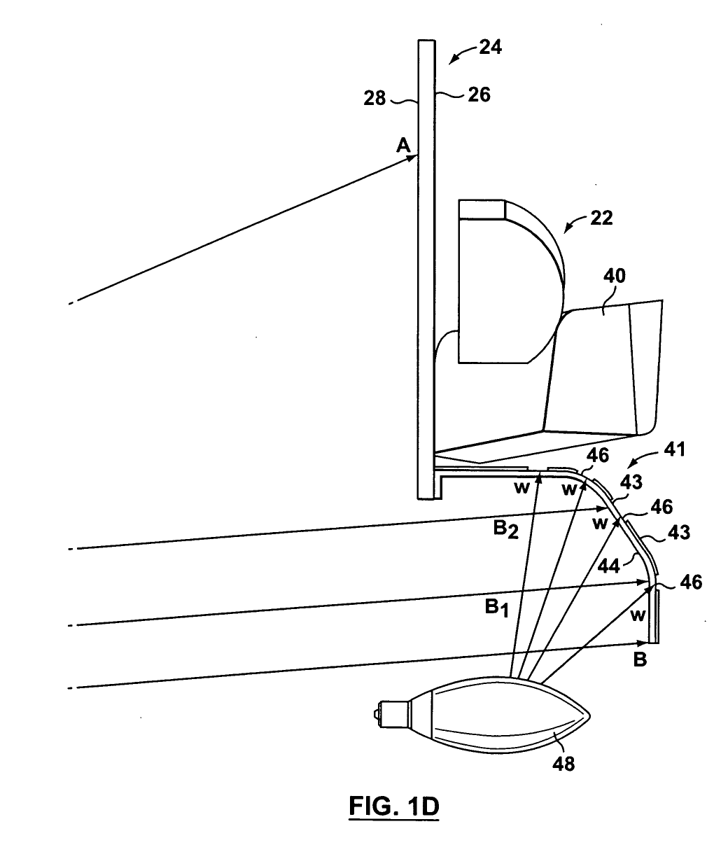

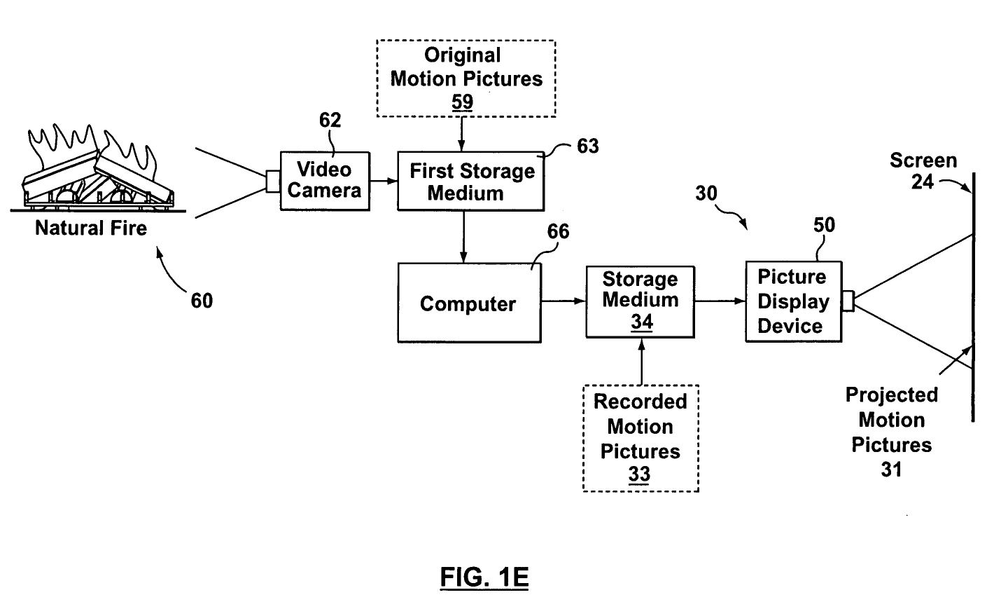

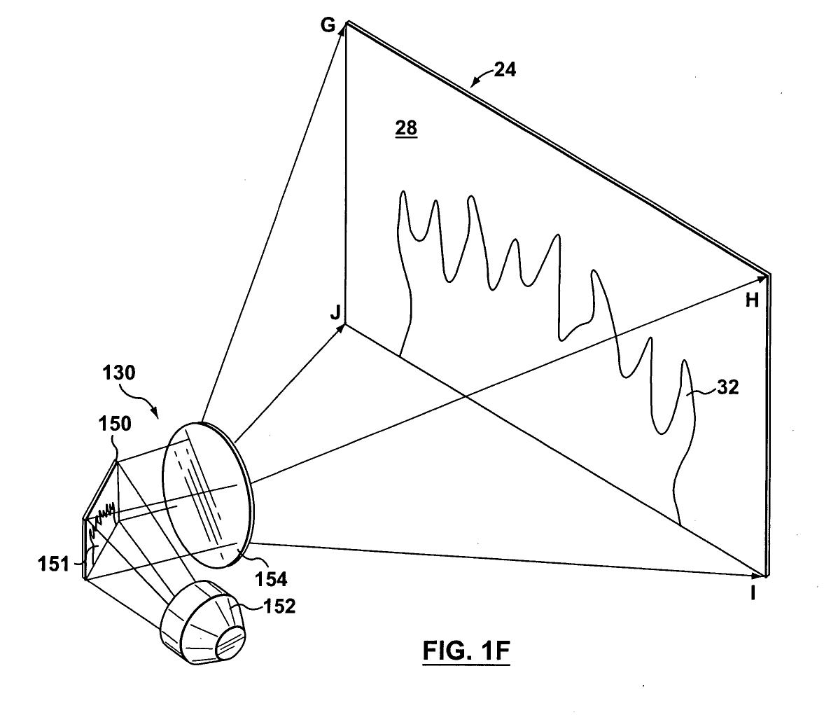

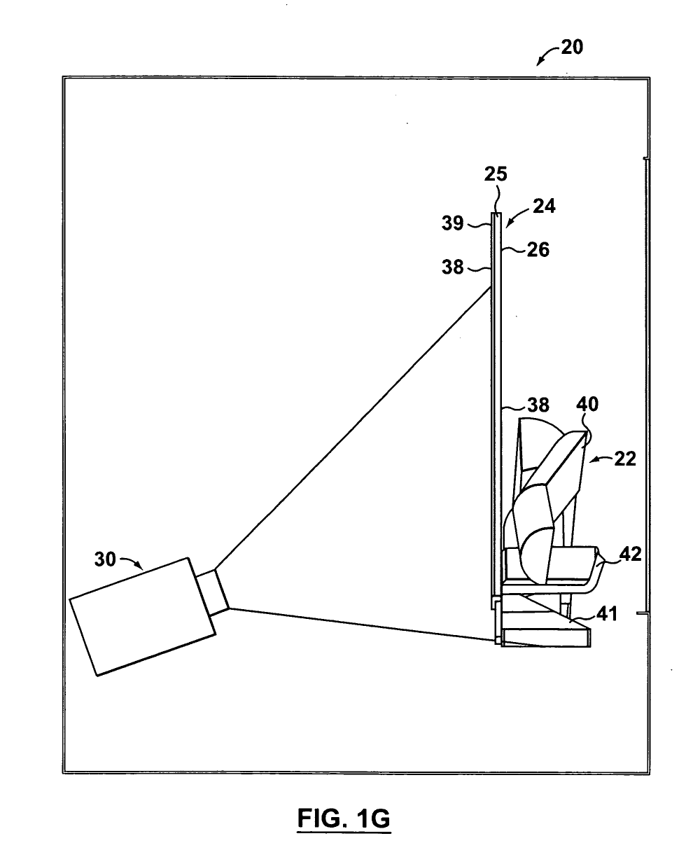

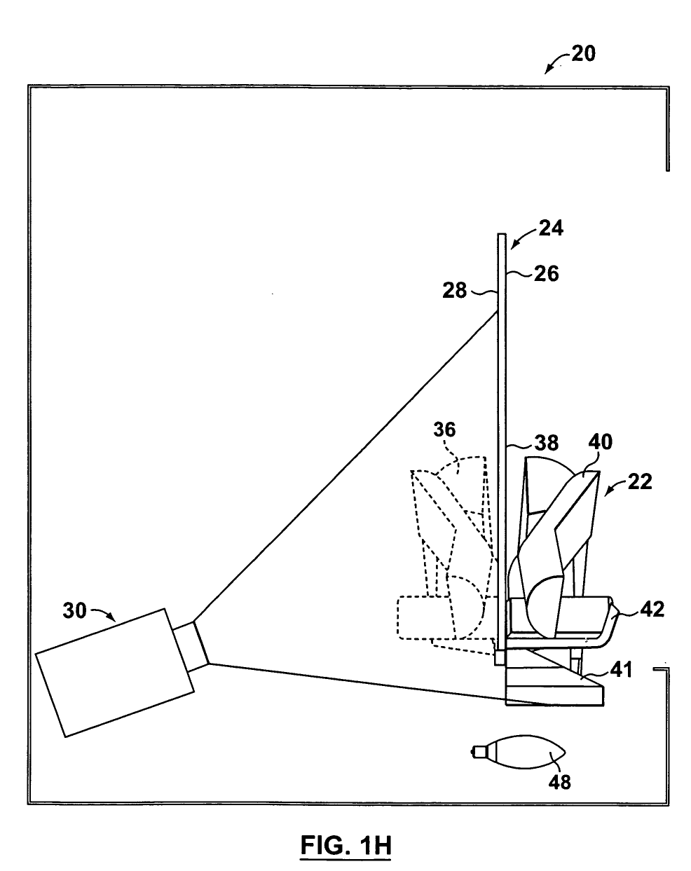

Reference is first made to FIGS. 1A and 1C to describe a preferred embodiment of a flame simulating assembly in accordance with the invention indicated generally by the numeral 20. The flame simulating assembly 20 includes a simulated fuel bed 22 and a screen 24 having a body portion 25 with a front surface 26 disposed proximal to the simulated fuel bed 22. The screen 24 also has a back surface 28 positioned opposite to the front surface 26. In the preferred embodiment, the flame simulating assembly 20 also includes a flame picture projector 30 for creating a plurality of motion pictures of flames 31 (represented by an outline of a picture of flames 32 in the drawings) and projecting light beams (schematically represented by arrows A and B in FIG. 1A) carrying the motion pictures of flames 31 to the back surface 28 of the screen 24, as will be described. The flame picture projector 30 creates the motion pictures 31 from recorded motion pictures of flames 33 stored in (or on) a storage medium 34 (FIG. 1E) accessible thereby. The screen 24 is adapted to display the motion pictures of flames 31 (FIG. 1B) at its front surface 26.

In the preferred embodiment, the front surface 26 is at least partially reflective (i.e., to provide specular reflection), for providing a reflected image 36 of the simulated fuel bed 22 (FIG. 1A). As a result, the image 36 appears to an observer (not shown) to be disposed at least partially behind the motion pictures of flames 31 displayed at the front surface 26, thereby providing an illusion of depth to an observer (not shown).

Preferably, the body portion 25 of the screen 24 is made of transparent or translucent material, such as glass, acrylic or perspex. The partially reflective surface 26 preferably is created by lightly silvering the front surface of the body portion 25, at least in a lower portion 38 thereof adjacent to the simulated fuel bed 22, as will be described. It will be appreciated by those skilled in the art that the front surface 26 need not be silvered in order for it to be at least partially reflective. For example, the front surface 26 (or the body portion 25, as the case may be) could be tinted to make it dark, and thus have a small degree of reflectivity accordingly. Alternatively, or in addition to tinting, the front surface 26 could be provided with a glossy finish, so that the front surface 26 is partially reflective. However, in the preferred embodiment, the front surface 26 is made partially reflective via silvering, as will be discussed.

In one embodiment, the back surface 28 of the screen 24 is the back surface of the body portion 25 (FIG. 1A). The back surface 28 preferably is treated so that it diffuses light directed to the back surface 28 from the flame picture projector 30. A variety of treatments of the back surface 28 can result in the diffusion of light through the screen 24. For example, the back surface 28 can be sandblasted, or matte ink can be printed onto the back surface 28. Alternatively, instead of treating a back surface of the body portion 25, a layer of translucent plastic 39 can be positioned adjacent to the body portion 25, to diffuse light directed to the plastic layer 39, as shown in FIG. 1G. In this embodiment, and as can be seen in FIG. 1G, the back surface of the plastic layer 39 is the back surface 28 of the screen 24. The light from the flame picture projector 30 is diffused as it passes through the plastic layer 39 to the body portion 25, to result in the motion pictures of flames being displayed at the front surface 26 of the screen 24.

As compared to the front surface of a screen in a known flame simulating assembly, the front surface 26 can be made relatively more reflective in the lower portion 38, to provide a better reflected image 33 of the simulated fuel bed 22, thereby providing a better illusion of depth to an observer (not shown). In the preferred embodiment, the relatively more reflective surface is achieved by depositing relatively thicker amounts of silvering material. In order to provide motion pictures 31 that are viewable at the front surface 26 when the front surface 26 is more reflective, a relatively intense light is provided by the flame picture projector 30.

Preferably, the simulated fuel bed 22 includes one or more simulated fuel elements 40 and a simulated ember bed 41. As shown, the simulated fuel elements 40 preferably are simulated wooden logs. However, the simulated fuel elements could be formed and colored to simulate other types of combustible fuel, e.g., coal.

The simulated ember bed 41 preferably is positioned below the simulated fuel elements 40. As can be seen in FIG. 1A, the simulated fuel bed 22 may include a simulated grate 42 disposed generally above the simulated ember bed 41 and supporting the simulated fuel elements 40. It will be understood that the simulated fuel bed 22 need not include the simulated grate 42. For example, as shown in FIG. 1D, simulated fuel elements 40 could be positioned directly on the simulated ember bed 41.

In the preferred embodiment, and as shown in FIG. 1D, the simulated ember bed 41 has an exterior surface 43 shaped and colored to simulate embers, and an opposed interior surface 44 which at least partially defines a compartment 45 inside the simulated ember bed 41. The simulated ember bed 41 preferably also includes a number of light-transmitting portions 46 which resemble glowing embers upon the transmission of light therethrough, as will be described.

Although various methods of manufacturing and various materials could be employed, in the preferred embodiment, the simulated ember bed 41 is injection molded. The simulated ember bed 41 may be made using any other suitable method, e.g., vacuum-forming or rotation molding. Preferably, the simulated ember bed 41 is made of orange or reddish-orange translucent plastic, and the exterior surface 43 is painted to resemble ashes and embers to provide an appearance appropriate for the type of fuel which is simulated by the simulated fuel elements 40.

Preferably, the simulated ember bed 41 is positioned so that light beams from the flame picture projector 30 are transmitted through the light-transmitting portions 46 to simulate glowing embers at the exterior surface 43 of the ember bed 41. Such beams of light are schematically represented in FIG. 1D by arrows B₁ and B₂.

Alternatively, the flame simulating assembly 20 includes an ember bed light source 48 positioned below the simulated ember bed 41 (FIGS. 1D, 1H). Preferably, the light-transmitting portions 46 of the simulated ember bed 41 are positioned in paths of light from the ember bed light source 48, resulting in the simulation of glowing embers at the exterior surface 43, at the light-transmitting portions 46. Light beams from the ember bed light source 48 are schematically represented by arrows W (FIG. 1D). Preferably, the ember bed light source 48 provides a flickering light, to provide a realistic simulation of glowing embers. Various devices for causing electric lights to flicker are known, and it will be understood that any suitable device could be used for causing the ember bed light source 48 to flicker. A light flickering device is disclosed in U.S. Pat. No. 6,385,881 (Hess), the entire specification of which is herein incorporated by reference.

As shown schematically in FIG. 1B, the flame picture projector 30 preferably includes a picture display device 50 for accessing the storage medium 34 to provide a first display 51 of the motion pictures of flames in such a manner that the motion pictures are projectable onto the back surface 28 of the screen 24. For example, the picture display device 50 can be a liquid crystal display (LCD) device, a device including liquid crystal on silicon, a DLP (digital light processing) device, or any other suitable display device. Because the motion pictures are projected onto the screen 24, the screen 24 is relatively inexpensive, for example, as compared to a flat panel display which is a LCD device.

As can be seen in FIG. 1B, the flame picture projector 30 preferably includes a projector light source 52 positioned to direct light therefrom through the first display 51 of the motion pictures towards the back surface 28, so that light beams (schematically represented by arrows C, D, E, and F in FIG. 1B) are directed towards the back surface 28 of the screen 24 carrying the motion pictures, to project the motion pictures of flames onto the screen 24. The flame picture projector 30 may also include a lens 54 which is formed and positioned to focus light from the projector light source 52. As is known in the art, where the lens 54 is included in the flame picture projector 30, the lens 54 may be positioned between the picture display device 50 and the back surface 28 of the screen 24, as shown in FIG. 1B. However, it will be appreciated by those skilled in the art that the lens 54 could, alternatively, be positioned between the projector light source 52 and the picture display device 50.

As shown in FIG. 1E, the motion pictures of flames 31 are created by the flame picture projector 30 from recorded pictures of flames 33 which are stored in (or on) a storage medium 34. Preferably, original motion pictures 59 of a natural fire 60 (FIG. 1E) are captured using a digital video camera 62 and recorded on a first storage medium 63, as shown schematically in FIG. 1E. However, it will be understood that the original motion pictures 59 could be captured by any suitable means (e.g., a suitable analog camera), and stored in (or on) any suitable storage medium, e.g., videotape.

In the preferred embodiment, the original motion pictures 59 of the natural fire 60 are modified to affect one or more preselected aspects thereof to provide an improved simulation effect, resulting in modified motion pictures 31. For example, the original motion pictures of flames 59 preferably are manipulated (i.e., edited) to result in a “loop” of motion pictures. The loop preferably is of sufficient duration that the repetition of motion pictures is generally not noticeable. As will be appreciated by those skilled in the art, care should be taken in preparing the loop to avoid a substantial deviation between the positions of flames in the motion pictures at the “end” of the loop, as compared to the positions of flames in the motion pictures at the “beginning” of the loop, as any such deviations would undermine the simulation effect sought to be achieved. In addition, differences in other elements shown in the motion pictures (i.e., at the “end”, compared to such elements at the “beginning”), such as the fuel in the natural fire 60, preferably are addressed by means of such modifications to the original motion pictures 59 as are necessary.

It will be appreciated by those skilled in the art that modification of the original motion pictures 59 is relatively easier to achieve if the original motion pictures 59 are captured using a digital camera. It will be appreciated by those skilled in the art that, where the original motion pictures 59 are captured as digital data, the modification of the original motion pictures 59 is conveniently done using a computer 66 with the appropriate software.

In addition to the creation of an endless loop, modifications to other aspects of the original motion pictures 59 may be desirable. For example, because at least a portion of the front surface 26 is preferably partially reflective (i.e., by silvering that portion, in the preferred embodiment), light from the projector light source 52 is affected by such silvering, by acquiring a somewhat bluish tinge in the motion pictures 31 displayed at the front surface 26. Also, it is preferable to increase the intensity of the light generated by the flames in the motion pictures 31 somewhat because the light from the projector light source 52 is somewhat impeded at the front surface 26, due to the relatively greater reflectivity of the front surface 26.

Once the modified motion pictures 33 are created, they are stored in (or on) the storage medium 34, which is operably connected to the picture display device 50. The storage medium 34 can be any suitable storage medium. In the preferred embodiment, the motion pictures 33 are in the form of digital data, and can be stored in any suitable means, such as a DVD, a CD-ROM, a mini-disk, or any suitable disk or semiconductor chip. However, the motion pictures 33 can be stored in any suitable format. For example, the storage medium 34 can be videotape. Preferably, the storage medium 34 is a silicon chip which is disposed in the flame picture projector 30. In addition, it will be understood that the storage medium can be located elsewhere, i.e., other than in the flame picture projector 30. Although the process of obtaining one sequence (or set) of motion pictures of flames has been described, it will be appreciated by those skilled in the art that a number of sets of motion pictures of flames could be stored in (or on) the storage medium 34.

In the preferred embodiment, the flame simulating assembly 20 includes a housing 70 comprising two sidewalls 72, a rear wall 74, a ceiling portion 76, and a front wall 78. Preferably, the housing 70 also includes a bottom wall 80. The front wall 78 preferably includes top and bottom panels 82, 84 which hold a transparent or translucent front panel 86 in place. Alternatively, the front wall 78 can exclude the panel 86, if preferred. Except for the front panel 86, the housing 70 preferably is made of sheet metal panels 87 which have been shaped and attached together in any suitable manner to form a cavity 88 in which the simulated fuel bed 22, the screen 24, and the flame picture projector 30 are positioned.

Preferably, the flame simulating assembly 20 includes the housing 70 in which the ceiling 76 is supported by the side walls 72 and the rear wall 74. The housing 70 also includes a substantially open front wall 78 disposed opposite to the rear wall 74. Also, the simulated fuel bed 22 is positioned in the housing 70 between the front wall 78 and the rear wall 74, and the screen 24 is disposed behind the simulated fuel bed 22. In the preferred embodiment, the flame picture projector 30 is also positioned in the cavity 88 formed in the housing 70.

In use, the picture display device 50 accesses the recorded pictures 33 stored in or on the storage medium 34 and provides the first display 51 of the motion pictures 31. The projector light source 52 projects light through the first display 51 towards the back surface 28 (and through the lens 54, if preferred), so that light beams from the projector light source 52 carrying the motion pictures 31 are directed towards the back surface 28. The light from the projector light source 52 is diffused at the back surface 28, and the motion pictures 31 are presented at the front surface 26.

Additional embodiments of the invention are shown in FIGS. 1F, 2, 3, 4A, 4B, and 5-9. In FIGS. 1F, 2, 3, 4A, 4B, and 5-9, elements are numbered so as to correspond to like elements shown in FIGS. 1A, 1B, 1C, 1D, 1E, 1G, and 1H.

Other devices for projecting motion pictures could be used. For example, in an alternative embodiment of the flame picture projector 130 (FIG. 1F), a projector light source 152 directs light onto the first display 151, provided by a picture display device 150. Light beams carrying the motion pictures (schematically represented by arrows G, H, I, J) are reflected by the display device 150 to a lens 154 which is formed and positioned to focus the light from the projector source 152, to provide appropriately-focused motion pictures of flames at the front surface 26 of the screen 24. The picture display device 150 can be an LCD device or any other suitable device, for example, a DLP device.

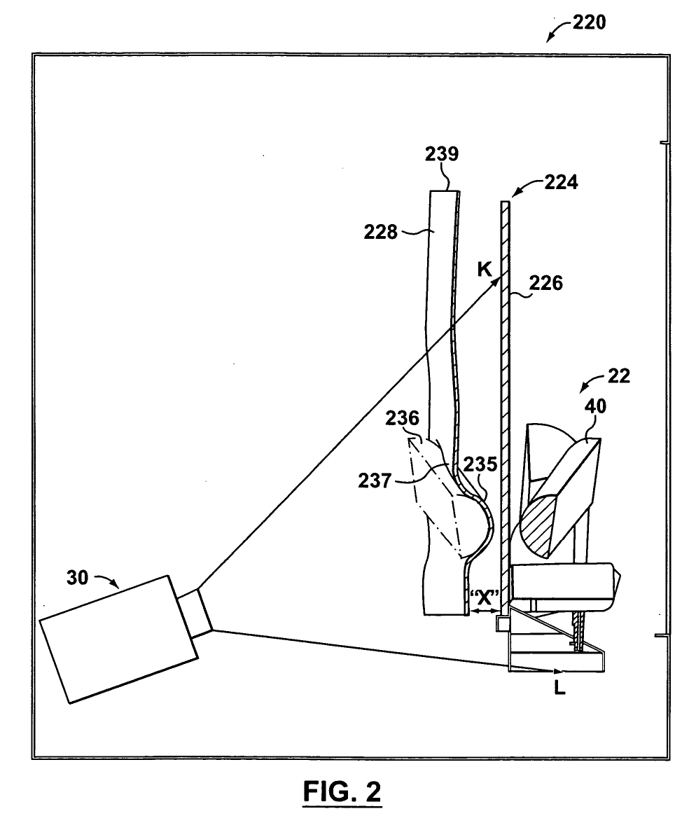

Preferably, in an alternative embodiment of the flame simulating assembly 220, the back surface 228 of the screen 224 is preferably non-planar so that the motion pictures of flames appear substantially in three dimensions at the front surface 226. The screen 224 preferably also includes a diffusing member 239 disposed behind a body portion 225, as shown in FIG. 2. The diffusing member 239 preferably is a plastic panel such as the plastic layer 39 (shown in FIG. 1G), formed and positioned as follows.

Preferably, the non-planar back surface 228 (i.e., the back surface of the diffusing member 239) is curved along its length and width. The non-planar back surface 228 includes a first curvature 235 in a substantially vertical direction and a second curvature 237 in a substantially horizontal direction (FIG. 2). The curvature of the non-planar back surface 228 is similar to the curvature of the diffusing member 46′″ disclosed in U.S. Pat. No. 6,363,636 (Hess et al.), the entire specification of which is herein incorporated by reference. By causing light from the flame picture projector 30 to travel through the varying thicknesses (relative to the front surface 226) of the back surface 228, the back surface 228 gives an apparent thickness to the motion pictures of flames displayed at the front surface 226, thereby creating the appearance of three-dimensional flames at the front surface 226. Light from the projector light source 52 is schematically represented in FIG. 2 by arrows K and L.

In the preferred embodiment, the diffusing member 239 is spaced apart from the body portion 225 by a predetermined distance, shown as “X” in FIG. 2. The light beams transmitted from the flame picture projector 30 and through the diffusing member 239 are further attenuated because the diffusing member 239 is spaced apart from the body portion 225, resulting in three-dimensional motion pictures of flames being displayed at the front surface 226.

As shown in FIG. 2, an image 236 of the simulated fuel bed 22 results from the partially reflective front surface 226. Preferably, the curvatures formed in the diffusing member 239 are positioned to take the image 236 into account, to further provide a three-dimensional simulation effect.

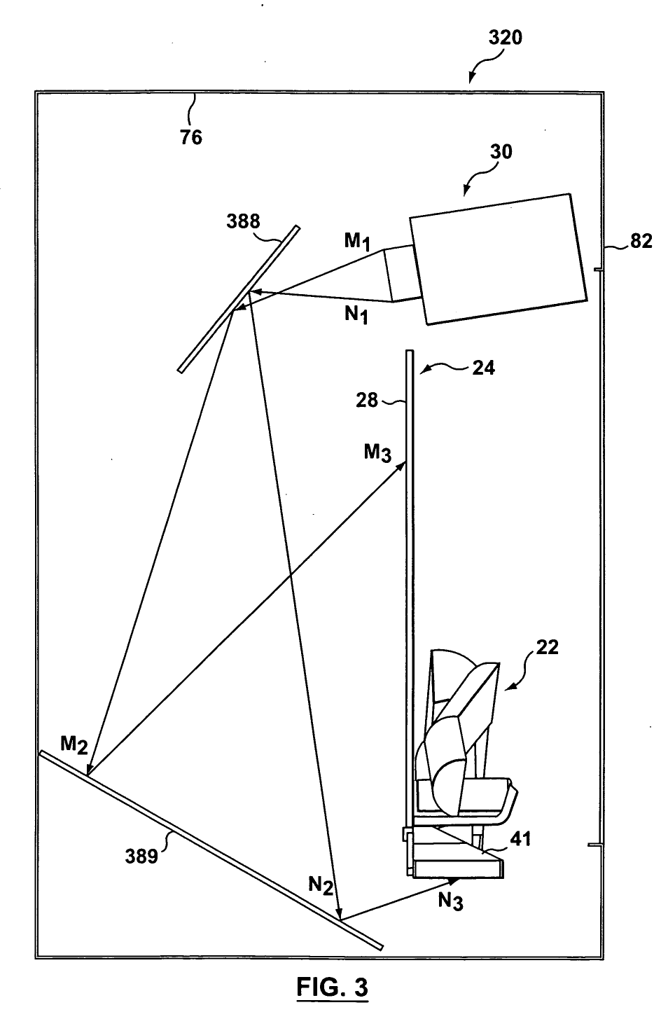

As shown in FIGS. 3, 4A, 4B, and 5, the position of the flame picture projector 30 relative to the screen 24 is variable. Where the flame picture projector 30 is not positioned so as to project light beams directly onto the back surface 28 mirrors 88 are used to reflect light beams from the flame picture projector 30 onto the back surface of the screen 24.

For example, in FIG. 3, an alternative embodiment of the flame simulating assembly 320 is shown in which the flame picture projector 30 is disposed near the ceiling 76 and the top panel 82 and directs light beams (schematically represented by arrows M₁, N₁) towards a first mirror 388. The reflected light beams (schematically represented by arrows M₂, N₂) are directed towards a second mirror 389 which is positioned to reflect the light beams (the reflected light beams being schematically represented by arrows M₃, N₃) towards the screen 24 and the simulated ember bed 41.

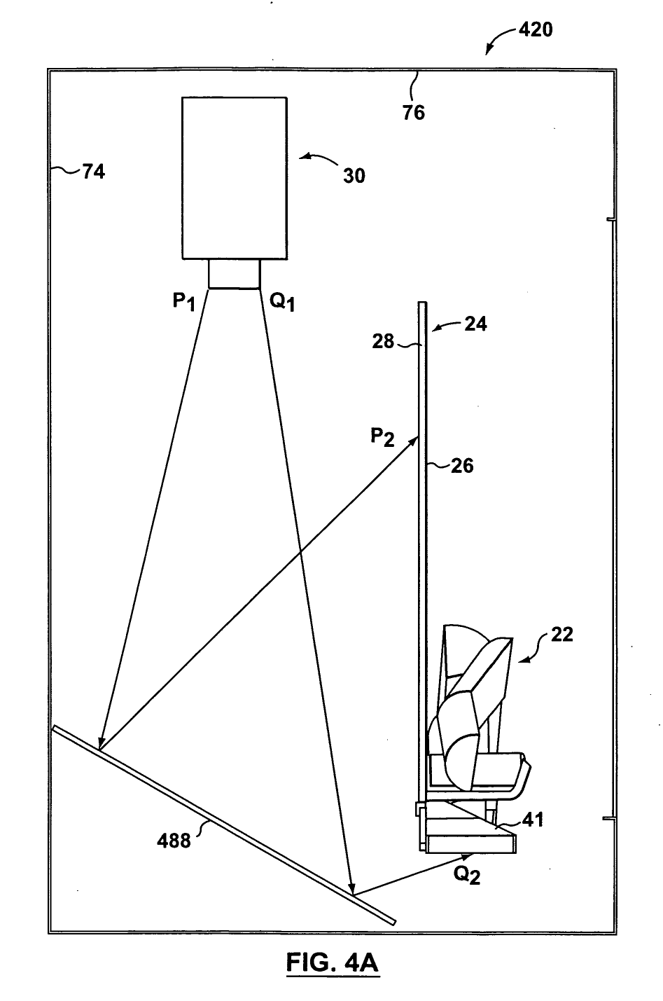

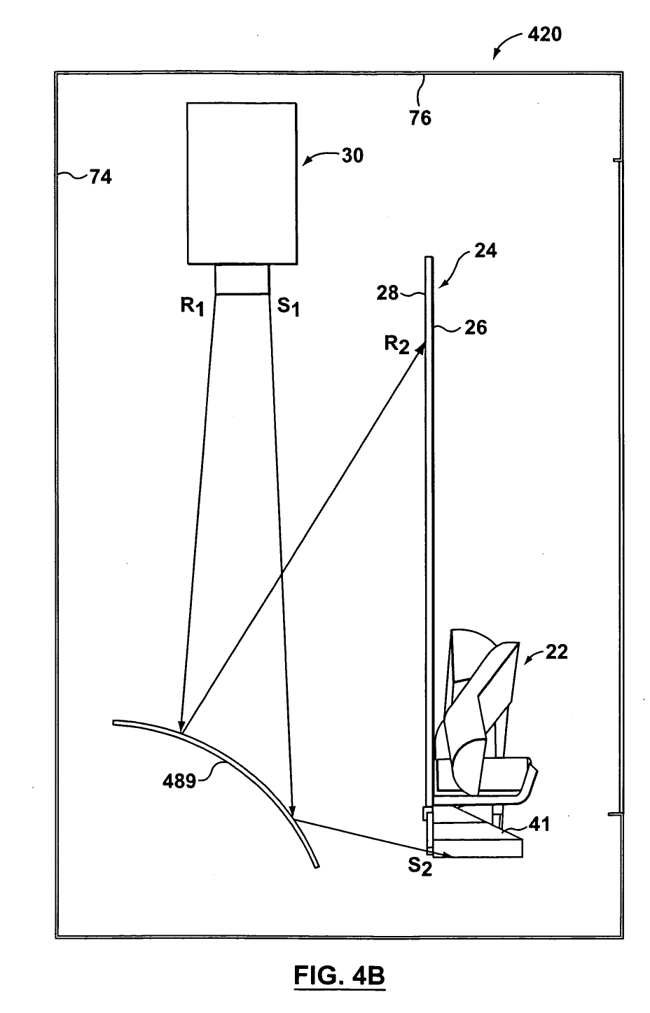

Another alternative embodiment of the flame simulating assembly 420 is shown in FIG. 4A. In this embodiment, the flame picture projector 30 is positioned at the ceiling 76 and spaced a short distance apart from the back wall 74. The flame picture projector 30 is pointing substantially downwards so that light beams directed therefrom (schematically represented by arrows P₁, Q₁) are reflected by a mirror 488 that in turn reflects light beams (schematically represented by arrows P₂, Q₂) towards the back surface 28 and the simulated ember bed 41.

In FIG. 4B, the flame simulating assembly 420 is shown in which the mirror 489 is convex. Light beams (schematically represented by arrows R₁, S₁) are reflected by the mirror 489 (as light beams schematically represented by arrows R₂, S₂) towards the back surface 28 and the simulated ember bed 41.

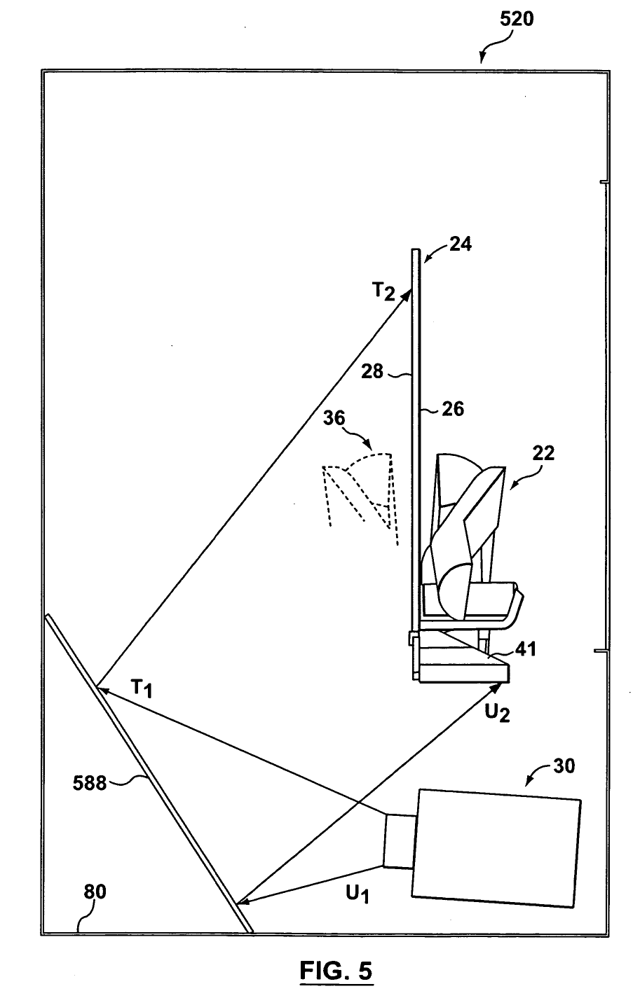

In FIG. 5, another alternative embodiment of the flame simulating assembly 520 of the invention is shown. In this embodiment, the flame picture projector 30 is disposed beneath the simulated ember bed 41. Light beams (schematically represented by arrows T₁, U₁) are reflected off a mirror 588 positioned to reflect the light beams towards the back surface 28 and the simulated ember bed 41 (represented schematically by arrows T₂, U₂).

It will be understood that the configurations shown in FIGS. 3, 4A, 4B, and 5 are exemplary only. Additional configurations will occur to those skilled in the art, and any such additional configurations are within the scope of the invention herein disclosed.

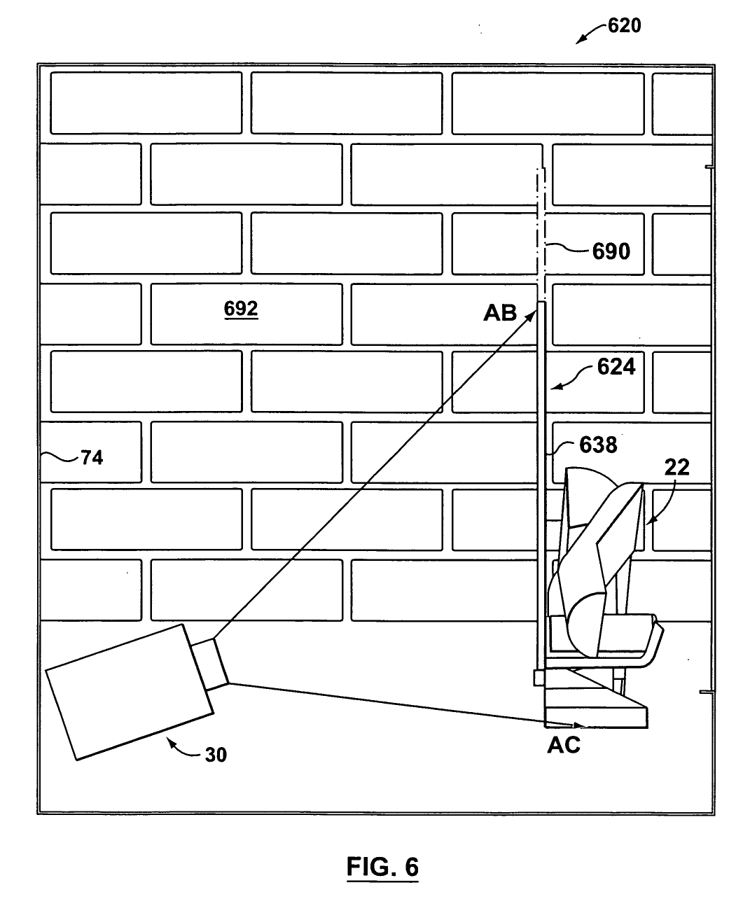

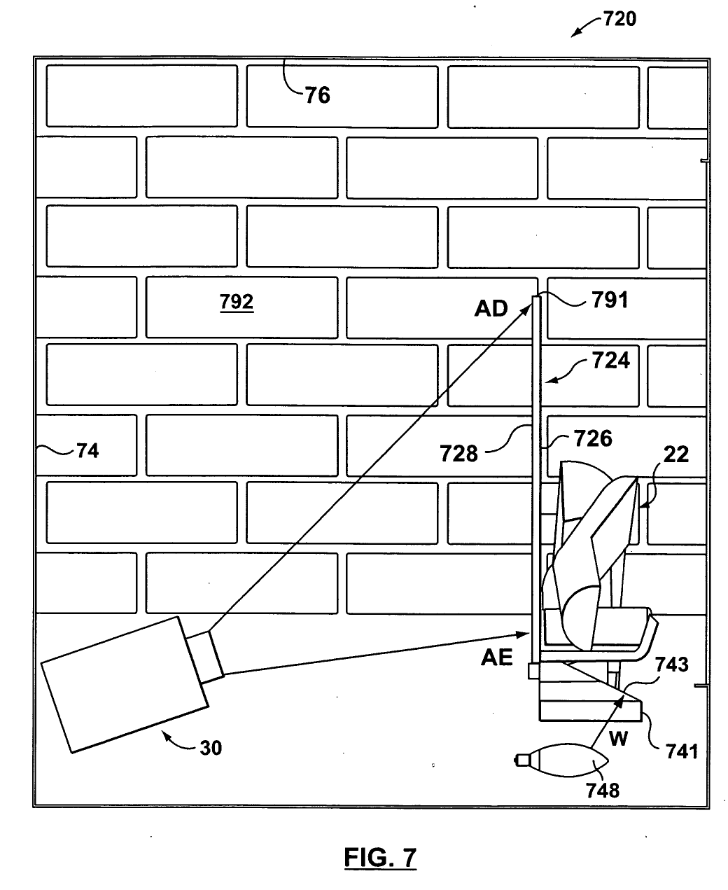

Additional alternative embodiments of the flame simulating assembly are shown in FIGS. 6 and 7. In FIG. 6, the flame simulating assembly 620 includes a screen 623 which includes a partially transparent portion 690. Except for the partially transparent portion 690, the screen 623 is treated to diffuse light directed to a back surface 628 thereof, as described above. Accordingly, the screen 623 diffuses light from the projector light source 52 which is directed to the back surface 628 of the screen 623, except for the portion 690. Light beams from the projector light source 52 are schematically represented in FIG. 6 by arrows AB and AC. The screen 623 also includes a front surface 626, and a lower portion 638 thereof is positioned adjacent to the simulated fuel bed 22. Although the front surface 626 of the screen 623 preferably includes a partially reflective region (i.e., in the lower portion 638), the screen 623 provides a depth perspective to the observer even where the front surface 626 does not include the partially reflective region.

Preferably, one or more simulated firebrick panels 692 are disposed on the side walls 72 and the back wall 74. The simulated firebrick panels 692 are viewable, in whole or in part, through the portion 690 of the screen 624, thereby providing a depth perspective similar to that viewable by the observer of a natural fire.

Accordingly, in one embodiment, the screen 623 does not have a partially reflective front surface 626. This embodiment could be manufactured at slightly lower cost.

However, it is preferred that the front surface 626 is at least partially reflective, to provide a reflected image (not shown in FIG. 6) of the simulated fuel bed 22, and thus an improved depth perspective. Preferably, the lower portion 638 of the screen 623 is at least partially reflective (i.e., providing specular reflection), to provide the reflected image of the simulated fuel bed 22, thereby improving the simulation effect.

The flame simulating assembly 720 shown in FIG. 7 includes a screen 723 which has a top edge 791 spaced apart from the ceiling 76. Also, the flame simulating assembly 720 preferably includes simulated firebrick panels 792 positioned on the side walls 72 and on the back wall 74. The panels 792 are partially viewable through the screen 724 and also above the top edge 791, thereby providing a depth perspective to improve the overall simulation effect.

The screen 723 diffuses the light beams from the projector light source 52 which are directed towards a back surface 728 of the screen 723. (The light beams are schematically represented by arrows AD and AE in FIG. 7.) A front surface 726 of the screen 723 is positioned opposite to the back surface 728. In the preferred embodiment, the front surface 726 includes a lower portion 738 which is partially reflective, for providing an image of the simulated fuel bed 22 so that the motion pictures of flames displayed at the front surface 726 appear to be substantially centrally located relative to the simulated fuel bed 22. Because of this, the partially reflective front surface 726 provides an illusion of a depth perspective.

Preferably, one or more simulated firebrick panels 792 are disposed on the side walls 72 and the back wall 74. The simulated firebrick panels 792 are viewable, in whole or in part, above the top edge 791 of the screen 723, thereby providing a depth perspective similar to that viewable by the observer of a natural fire.

Accordingly, the screen 723 provides a depth perspective to the observer even where the front surface 726 does not include the partially reflective region. Accordingly, in one embodiment, the screen 723 does not have a partially reflective front surface 726.

The embodiments of the screens 623 and 723 which include partially reflective front surfaces are disclosed in U.S. patent application Ser. No. 10/759,143 (Hess et al.), the entire specification of which is herein incorporated by reference.

Alternatively, and as shown in FIG. 7, the flame simulating assembly 720 also includes one or more ember bed light sources 748. In this embodiment, the light-transmitting portions of the simulated ember bed 741 are positioned in a path of light (schematically represented by arrow W in FIG. 7) from the ember bed light source 748 so that light is transmitted through the light-transmitting portions of the simulated ember bed 741, to simulate glowing embers. In the preferred embodiment, the ember bed light source 748 is caused to flicker, to simulate flickering light from glowing embers.

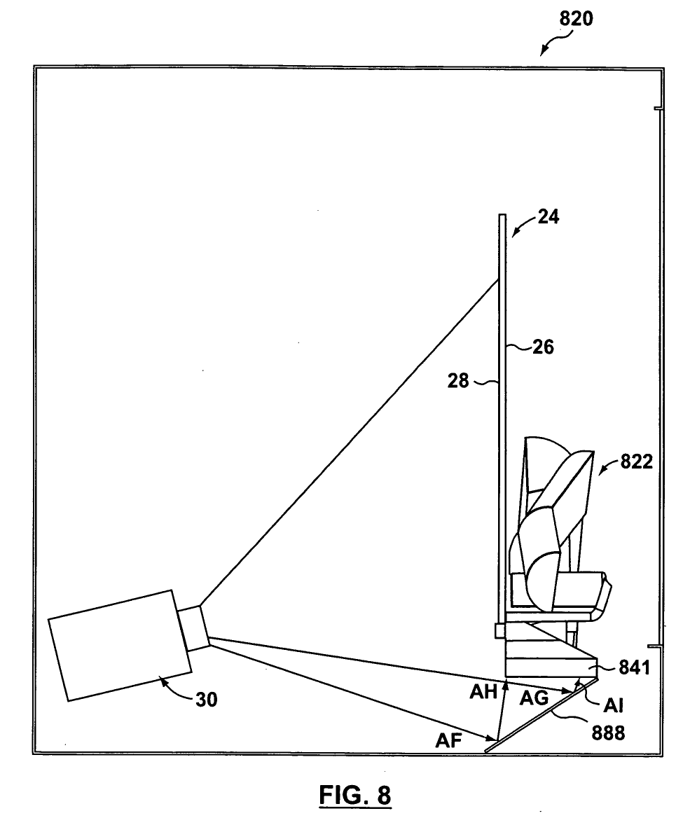

Another alternative embodiment of the flame simulating assembly 820 is shown in FIG. 8. In the flame simulating assembly 820, a mirror 888 is positioned underneath the simulated ember bed 841. Preferably, the flame picture projector 30 is positioned so that at least a portion of the light beams projected thereby are directed onto the mirror 888. The light beams directed onto the mirror 888 are schematically represented by the arrows AF, AG (FIG. 8). The light beams are reflected by the mirror 888 upwardly into the simulated ember bed 841 (schematically represented in FIG. 8 as arrows AH, AI), through light-transmitting portions 846 of the simulated ember bed 841, thereby simulating glowing embers.

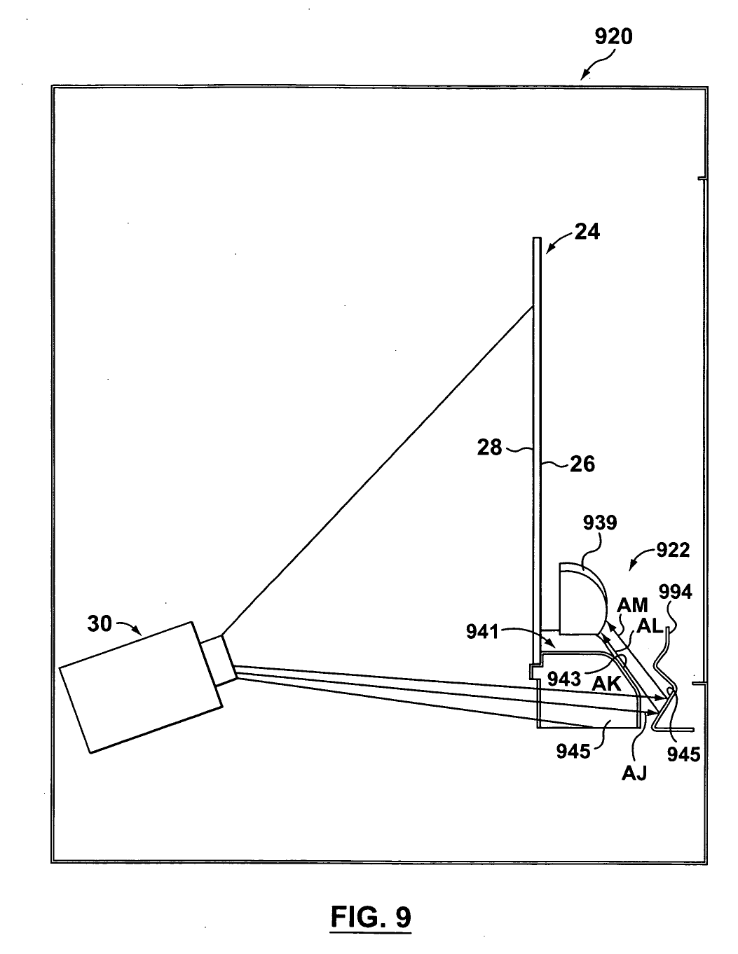

In FIG. 9, another embodiment of the flame simulating assembly 920 is shown. In the flame simulating assembly 920, a front reflector 994 is positioned in front of the simulated ember bed 941. The front reflector 994 is described in more detail in U.S. Pat. No. 6,564,485 (Hess) and U.S. Pat. No. 6,615,519 (Hess), and in U.S. patent application Ser. No. 10/312,008 (Hess), the entire specifications of which are herein incorporated by reference.

The front reflector 994 is positioned so that at least portions of the light beams projected into a compartment 945 of the ember bed 941 are directed to a reflective surface 995 of the front reflector 994. Such light beams are reflected by the surface 995 onto the exterior surface 943 of the ember bed 941, as well as onto the simulated fuel elements 940 of the simulated fuel bed 922. For example, as shown in FIG. 9, beams of light (schematically represented by arrows AJ and AK) are directed to the front reflector 994, and beams of light reflected from the front reflector (schematically represented by arrows AL and AM) are directed towards the simulated fuel elements 940. Because the light directed onto the exterior of the simulated ember bed 941 and the simulated fuel elements 940 is similar to lighting effects provided by a natural fire relative to the fuel bed thereof, the reflection of light from the front reflector 994 provides a further improved simulation effect.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. A flame simulating assembly including:
a simulated fuel bed;
a screen having a front surface disposed proximal to the simulated fuel bed and a back surface positioned opposite to the front surface;
a flame picture projector for creating a plurality of motion pictures of flames from recorded motion pictures of flames stored on a storage medium accessible thereby and projecting light beams carrying said motion pictures of flames to the back surface of the screen;
the screen being adapted to display said motion pictures of flames at its front surface; and
the front surface of the screen being at least partially reflective, for providing a reflected image of the simulated fuel bed appearing to be disposed at least partially behind said motion pictures of flames displayed at the front surface,
whereby said motion pictures of flames appear to be substantially centrally positioned relative to the simulated fuel bed.

2. A flame simulating assembly according to claim 1 in which said recorded motion pictures of flames comprise modified motion pictures, said modified motion pictures comprising original motion pictures of flames in a natural fire modified to affect at least one preselected aspect thereof to provide an improved simulation effect.

3. A flame simulating assembly according to claim 1 in which the back surface of the screen is non-planar such that said motion pictures of flames are displayed in three dimensions at the front surface.

4. A flame simulating assembly according to claim 1 in which:
the simulated fuel bed includes at least one simulated fuel element and a simulated ember bed, the simulated ember bed being positioned below said at least one simulated fuel element;
the simulated ember bed having an exterior surface shaped and colored to simulate embers and an opposed interior surface; and
the simulated ember bed including a plurality of light-transmitting portions for resembling glowing embers upon light being transmitted therethrough.

5. A flame simulating assembly according to claim 4 in which the simulated ember bed is positioned such that the light beams from the flame picture projector are transmitted through the light-transmitting portions to simulate glowing embers.

6. A flame simulating assembly according to claim 5 additionally including an ember bed mirror positioned to direct light beams from the flame picture projector substantially towards the light-transmitting portions.

7. A flame simulating assembly according to claim 5 additionally including a front reflector positioned in front of the simulated ember bed and outside a compartment at least partially defined by the interior surface, for reflecting light beams from the flame picture projector onto the exterior surface and said at least one simulated fuel element.

8. A flame simulating assembly according to claim 5 additionally including:
at least one ember bed light source; and
the light-transmitting portions of the simulated ember bed being positioned in a path of light from said at least one ember bed light source such that said light is transmitted through the light-transmitting portions to simulate glowing embers.

9. A flame simulating assembly according to claim 1 in which the screen includes an upper portion disposed distal to the simulated fuel bed, the upper portion being at least partially transparent.

10. A flame simulating assembly according to claim 1 in which the flame picture projector includes a picture display device for accessing the storage medium to provide a first display of said motion pictures of flames, said first display being projectable onto the back surface of the screen.

11. A flame simulating assembly according to claim 10 in which the flame picture projector includes at least one projector light source positioned to direct light therefrom through the first display to project the motion pictures of flames onto the back surface of the screen.

12. A flame simulating assembly according to claim 10 in which the flame picture projector includes at least one projector light source positioned to direct light therefrom onto the first display, said light being reflected by the picture display device to project the motion pictures of flames onto the back surface of the screen.

13. A flame simulating assembly according to claim 4 additionally including:
at least one ember bed light source;
the light-transmitting portions of the simulated ember bed being positioned in a path of light from said at least one ember bed light source such that said light is transmitted through the light-transmitting portions to simulate glowing embers at the exterior surface of the simulated ember bed.

14. A flame simulating assembly according to claim 1 additionally including at least one mirror for reflecting the light beams from the flame picture projector towards the back surface of the screen.

15. A flame simulating assembly according to claim 14 in which said at least one mirror is non-planar.

16. A flame simulating assembly according to claim 4 additionally including at least one mirror for reflecting the light beams from the flame picture projector towards the back surface of the screen and the light-transmitting portions of the simulated ember bed.

17. A flame simulating assembly including:
a housing having a ceiling supported by two side walls and a rear wall, the housing including a substantially open front wall disposed opposite to the rear wall;
a simulated fuel bed positioned between the front wall and the rear wall;
a screen disposed behind the simulated fuel bed;
the screen including a front surface disposed proximal to the simulated fuel bed and a back surface disposed opposite to the front surface;
a flame picture projector for creating a plurality of motion pictures of flames and projecting light beams carrying said motion pictures of flames to the back surface of the screen;
the screen being adapted to display said motion pictures of flames at its front surface; and
the front surface of the screen being at least partially reflective, for providing a reflected image of the simulated fuel bed appearing to be disposed at least partially behind said motion pictures of flames displayed at the front surface,
whereby said motion pictures of flames appear to be substantially centrally positioned relative to the simulated fuel bed.

18. A flame simulating assembly according to claim 17 in which the back surface of the screen is non-planar such that said motion pictures of flames are displayed in three dimensions at the front surface.

19. A flame simulating assembly according to claim 17 in which:
the simulated fuel bed includes at least one simulated fuel element and a simulated ember bed, the simulated ember bed being positioned below said at least one simulated fuel element;
the simulated ember bed having an exterior surface shaped and colored to simulate embers and an opposed interior surface; and
the simulated ember bed including a plurality of light-transmitting portions resembling glowing embers upon light being transmitted therethrough.

20. A flame simulating assembly according to claim 19 in which the simulated ember bed is positioned such that the light beams from the flame image projector are transmitted through the light-transmitting portions to simulate glowing embers.

21. A flame simulating assembly according to claim 20 additionally including:
at least one ember bed light source; and
the light-transmitting portions of the simulated ember bed being positioned in a path of light from said at least one ember bed light source such that said light is transmitted through the light-transmitting portions to simulate glowing embers at the exterior surface of the simulated ember bed.

22. A flame simulating assembly according to claim 17 in which the screen includes an upper portion disposed distal to the simulated fuel bed, the upper portion being at least partially transparent.

23. A flame simulating assembly according to claim 22 in which the rear wall includes an exposed portion viewable through the upper portion, and the side walls and the exposed portion are covered with simulated firebrick for simulating a firebox.

24. A flame simulating assembly according to claim 17 in which the screen has a top edge spaced a predetermined distance apart from the ceiling, to permit observation of at least an exposed portion of the rear wall of the housing.

25. A flame simulating assembly according to claim 24 in which the exposed portion of the rear wall and the side walls are covered with a simulated firebrick covering for simulating a firebox.

26. A flame simulating assembly according to claim 19 additionally including:
at least one ember bed light source; and
the light-transmitting portions of the simulated ember bed being positioned in a path of light from said at least one ember bed light source such that said light is transmitted through the light-transmitting portions to simulate glowing embers.

27. A flame simulating assembly according to claim 17 additionally including at least one mirror for reflecting the light beams from the flame picture projector towards the screen.

28. A flame simulating assembly according to claim 27 in which said at least one mirror is non-planar.

29. A flame simulating assembly according to claim 19 additionally including at least one mirror for reflecting the light beams from the flame picture projector towards the screen and the light-transmitting portions of the simulated ember bed.

30. A flame simulating assembly according to claim 17 in which the flame picture projector includes:
a picture display device, for providing a first display of said motion pictures of flames; and
a storage medium on which recorded motion pictures are stored.

31. A flame simulating assembly according to claim 30 in which the recorded motion pictures additionally include motion pictures of flames in a natural fire in which preselected characteristics thereof have been modified to provide at least one predetermined simulation effect.

32. A flame simulating assembly according to claim 30 in which the flame picture projector includes at least one projector light source positioned to direct light therefrom through the first display to project the motion pictures of flames onto the back surface of the screen.

33. A flame simulating assembly according to claim 30 in which the flame picture projector includes at least one projector light source positioned to direct light therefrom onto the first display, said light being reflected by the picture display device to project the motion pictures of flames onto the back surface of the screen.
